(19) United States
(12) Patent Application Publication
(10) Pub. No.: US 2020/0235617 A1
(43) Pub. Date: Jul. 23, 2020

(54) ELECTRIC MACHINE ASSEMBLY

(71) Applicant: Ford Global Technologies, LLC, Dearborn, MI (US)

(72) Inventors: Chun Tang, Canton, MI (US); Joel Hetrick, Ann Arbor, MI (US); Daniel Zu, Lancaster, CA (US)

(21) Appl. No.: 16/252,599

(22) Filed: Jan. 19, 2019

(51) Int. Cl. H02K 1/18

(52) U.S. Cl. CPC H02K 1/185; B60Y 2200/92; B60K 6/26; B60Y 2400/604; B60Y 2200/91

(57) ABSTRACT

An electric machine assembly including a housing and a stator is provided. The housing may define a cavity and an inner surface having pockets spaced radially about a housing central axis. The stator may be disposed within the cavity and define an outer surface having tabs spaced from one another radially about a stator central axis and each tab including opposing circumferential sides. The housing and stator may be arranged with one another such that each of the opposing circumferential sides contacts a side of a respective pocket to create interference therebetween. Each tab may further include a tab outer surface and each of the pockets may be sized such that a space is defined between each tab outer surface and a respective pocket side.

### TECHNICAL FIELD

The present disclosure relates to a structure of an electric machine assembly.

### BACKGROUND

A stator of an electric machine assembly may be shrink-fit into an electric machine housing. An interference between a housing surface and an outer stator surface retain the stator in position. The interference creates radial pressure at the outer stator surface which results in compression stress to the stator. This stress increases stator operational losses and reduces an overall efficiency of the electric machine assembly.

### SUMMARY

An electric machine assembly includes a housing and a stator. The housing defines a cavity and an inner surface having pockets spaced radially about a housing central axis. The stator is disposed within the cavity and defines an outer surface having tabs spaced from one another radially about a stator central axis and each tab including opposing circumferential sides. The housing and stator are arranged with one another such that each of the opposing circumferential sides contacts a side of a respective pocket to create interference therebetween. Each tab may further include a tab outer surface and each of the pockets may be sized such that a space is defined between each tab outer surface and a respective pocket side.

The housing and stator may be further arranged with one another such that the housing pulls the stator into tension when exposed to a temperature over a first predetermined threshold. The housing and stator may be further arranged with one another such that the housing pushes the stator into compression when exposed to a temperature below a second predetermined threshold. The housing and stator may be further arranged with one another such that the interference between the tab and pocket is comprised of at least one force other than a friction force to prevent slippage of the stator within the cavity of the housing. Each of the tabs may include an outer side and a pair of radial sides arranged with one another to define a wedge shape and each of the radial sides may define an angle offset from the stator central axis. The housing central axis and the stator central axis may be oriented parallel with one another.

An electric machine assembly includes a housing and a stator. The housing defines a cavity and an inner surface having pockets spaced radially about a housing central axis. The stator is disposed within the cavity and defines an outer surface having T-shaped tabs spaced from one another circumferentially about a stator central axis and each tab including an upper portion and a base portion. Each pocket defines a T shape corresponding to one of the T-shaped tabs. The housing and stator are arranged with one another such that a first interference is generated between the upper portions of the T-shaped tabs and a surface of a respective pocket. The housing and stator may be further arranged with one another such that as the housing expands due to exposure to a temperature above a first temperature threshold the stator is pulled into tension and such that as the housing contracts due to exposure to a temperature below a second predetermined threshold the stator is pushed into compression.

Each base portion may define a radial axis that intersects the stator central axis. The first interference may further be generated due to rotation of the stator and the housing during operation thereof. The housing and stator may be further arranged with one another such that the first interference between the upper portions of the T-shaped tabs and a surface of a respective pocket is comprised of at least one force other than a friction force to prevent slippage of the stator within the cavity of the housing. The housing and stator may be further arranged with one another such that a second interference is generated at a stator outer housing surface between two of the T-shaped tabs and an inner housing surface. The first interference may be generated along a first radial axis intersecting the stator central axis and the second interference may be generated along a second radial axis intersecting the stator central axis in a direction opposite the first interference.

An electric machine assembly includes a housing, a stator, and an insert member. The housing defines a cavity and defines an inner surface having a first insert pocket portion. The stator is disposed within the cavity and defines an outer surface having a second insert pocket portion. The housing and stator are arranged with one another such that the portions align with one another to define an insert pocket to receive the insert member therein. The housing and stator may be further arranged with one another such that each insert member is located relative to a stator central axis such that magnetic flux generated by operation of the stator is not substantially blocked by the insert member. The first insert pocket portion of the insert pocket and the second insert pocket portion of the insert pocket may each define an I shape. The first insert pocket portion of the insert pocket may be an outer wedge-shaped pocket and the second insert pocket portion of the insert pocket may be an inner wedge-shaped pocket.

The insert member may define a dual-wedge shape and the housing and the stator may be further arranged with one another to receive the dual-wedge shaped insert member within one of the inner wedge-shaped pockets and one of the outer wedge-shaped pockets. The housing and stator may be further arranged with one another such that an interference is generated between the outer surface of the stator between two second insert pocket portions and the inner surface of the housing. The housing and the stator may be further arranged with one another such that an interference therebetween is comprised of at least one force other than a friction force to prevent slippage of the stator within the cavity of the housing.

### BRIEF DESCRIPTION OF THE DRAWINGS

FIG. 1A is a schematic diagram illustrating an example of an electrified vehicle.

FIG. 1B is a perspective, partially exploded view of an example of a portion of a vehicle electric machine.

FIG. 2A is a top plan view illustrating an example of a portion of a vehicle electric machine.

FIG. 2B is a detailed top plan view of a portion of the vehicle electric machine of FIG. 2A illustrating an example of radial pressure forces on a stator.

FIG. 2C is a chart illustrating an example of a stress impact on iron loss of a lamination of electric steel.

FIG. 3A is a top plan view of an example of a portion of a prior art vehicle electric machine.

FIG. 3B is a detailed view of a portion of the vehicle electric machine of FIG. 3A.

FIG. 4A is a top plan view of an example of a portion of a vehicle electric machine.

FIG. 4B is a detailed view of a portion of the vehicle electric machine of FIG. 4A.

FIG. 4C is a top plan view of an example of a portion of a vehicle electric machine.

FIG. 4D is a detailed view of a portion of the vehicle electric machine of FIG. 4C.

FIG. 5A is a top plan view of an example of a portion of a vehicle electric machine.

FIG. 5B is a detailed view of a portion of the vehicle electric machine of FIG. 5A.

FIG. 6A is a top plan view of an example of a portion of a vehicle electric machine.

FIG. 6B is a detailed view of a portion of the vehicle electric machine of FIG. 6A.

FIG. 6C is a top plan view of an example of a portion of a vehicle electric machine.

FIG. 6D is a detailed view of a portion of the vehicle electric machine of FIG. 6C.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

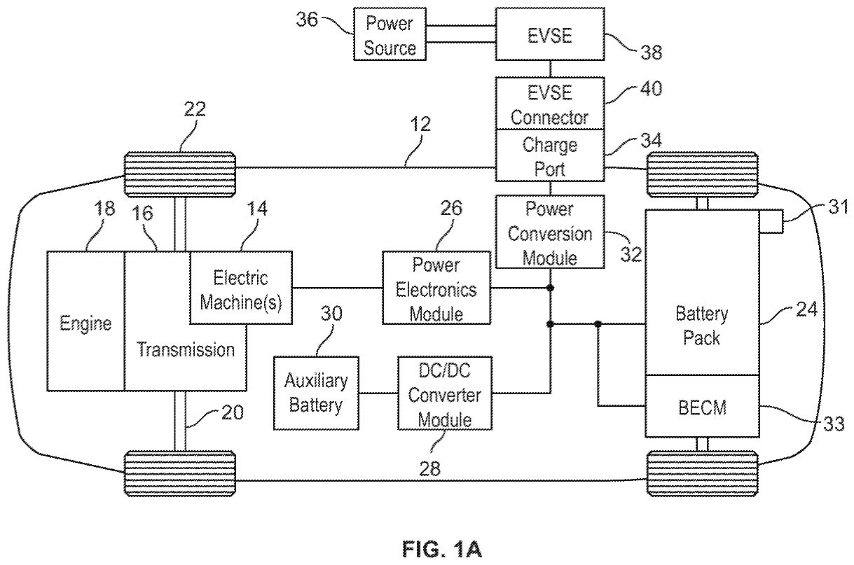

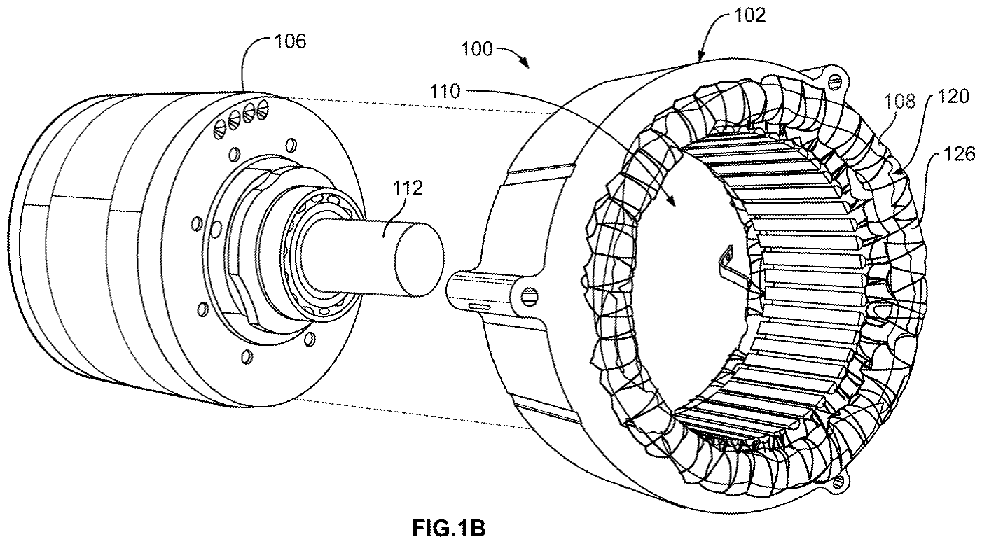

FIG. 1A illustrates a schematic diagram illustrating an example of an electrified vehicle. In this example, the electrified vehicle is a plug-in electric vehicle referred to as a vehicle 12 herein. The vehicle 12 may include one or more electric machines 14 mechanically connected to a hybrid transmission 16. Each of the electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to wheels 22. The electric machines 14 may provide propulsion and deceleration capability when the engine 18 is turned on or off. The electric machines 14 may also operate as generators and provide fuel economy benefits by recovering energy that would normally be lost as heat in the friction braking system. The electric machines 14 may also provide reduced pollutant emissions since the vehicle 12 may be operated in electric mode under certain conditions.

A traction battery 24 stores energy that may be used by the electric machines 14. The traction battery 24 typically provides a high voltage DC output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors may isolate the traction battery 24 from other components when opened and may connect the traction battery 24 to other components when closed. The power electronics module 26 is also electrically connected to the electric machines 14 and provides an ability to bi-directionally transfer electrical energy between the traction battery 24 and the electric machines 14. For example, a typical traction battery 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. For a pure electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In a typical vehicle, the low-voltage systems are electrically connected to an auxiliary battery 30 (e.g., a twelve-volt battery).

A battery electrical control module (BECM) 33 may be in communication with the traction battery 24. The BECM 33 may act as a controller for the traction battery 24 and may also include an electronic monitoring system that manages temperature and charge state of each battery cell of the traction battery 24. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36 such as an electrical outlet. The external power source 36 may be electrically connected to an electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The charge connector 40 may have pins that mate with corresponding recesses of the charge port 34.

The various components discussed above may have one or more associated controllers to control and monitor the operation of the components. The controllers may communicate via a serial bus (e.g., a controller area network (CAN)) or via discrete conductors.

FIG. 1B is a partially exploded view illustrating an example of portions of an electric machine assembly for an electrified vehicle, referred to generally as an electric machine assembly 100 herein. The electric machine assembly 100 may include a stator core 102 and a rotor 106. As mentioned above, electrified vehicles may include more than one electric machine. In an example with two electric machines, one of the electric machines may function primarily as a motor and the other may function primarily as a generator. The motor may operate to convert electricity to mechanical power and the generator may operate to convert mechanical power to electricity. The stator core 102 may define a cavity 110. The rotor 106 may be sized for disposal and operation within the cavity 110. A shaft 112 may be operably connected to the rotor 106 and may be coupled to other vehicle components to transfer mechanical power therefrom.

Windings 120 may be disposed within the cavity 110 of the stator core 102. In an electric machine motor example, current may be fed to the windings 120 to obtain a rotational force on the rotor 106. In an electric machine generator example, current generated in the windings 120 by a rotation of the rotor 106 may be used to power vehicle components. Portions of the windings 120, such as windings 126, may protrude from the cavity 110. During operation of the electric machine assembly 100, heat may be generated along the windings 120 and windings 126. The rotor 106 may include magnets such that rotation of the rotor 106 in cooperation with an electric current running through the windings 126 generates one or more magnetic fields. For example, three-phase sinusoidal electric current running through the windings 126 may generate a rotating magnetic field. Magnets of the rotor 106 may magnetize and rotate with the rotating magnetic field to rotate the shaft 112 for mechanical power.

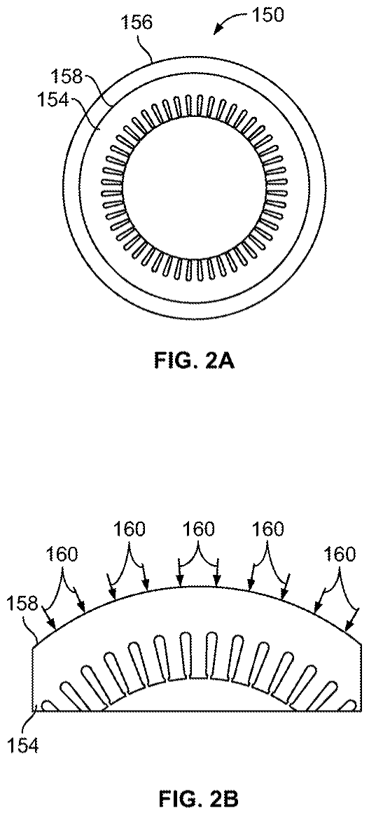

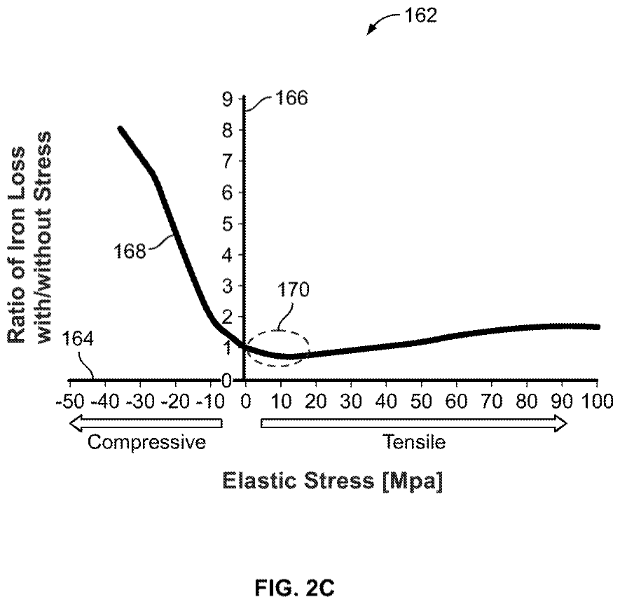

FIG. 2A is a top plan view of a portion of a vehicle electric machine assembly, referred to generally as an electric machine assembly 150 herein. The electric machine assembly 150 includes a stator 154 disposed within a housing 156. An interference surface 158 is defined at a region in which the stator 154 and the housing 156 contact one another. In one example, the interference surface 158 may be located at a portion of the stator 154 referred to as a back-iron portion. The interference surface 158 receives compressive radial pressure during operation of the electric machine assembly 150. For example, FIG. 2B illustrates an example of the radial pressure received during operation as represented by radial force arrows 160. These compressive radial pressure forces generate a compressive stress across the stator 154 resulting in increased motor losses. In one example, the motor losses are energy losses resulting from heat energy loss.

FIG. 2C is a chart illustrating an example of a stress impact on iron loss of a lamination of electric steel, referred to generally as a chart 162 herein. A stator core of an electric machine is typically made of a stack of electric steel laminations. Iron loss of the electric steel is affected by an elastic stress received by the stator core. In FIG. 2C, an X-axis 164 represents elastic stress in Mpa and further categorizes the elastic stress as compressive or tensile. A Y-axis 166 represents a ratio of iron loss with and without stress. Plot 168 is a curve illustrating an example of an impact of elastic stress as related to iron loss of electric steel. As shown by chart 162, compressive stress typically results in a higher amount of iron loss in comparison to tensile stress. Under certain scenarios, a small amount of tensile stress may assist in reducing iron loss as shown by region 170.

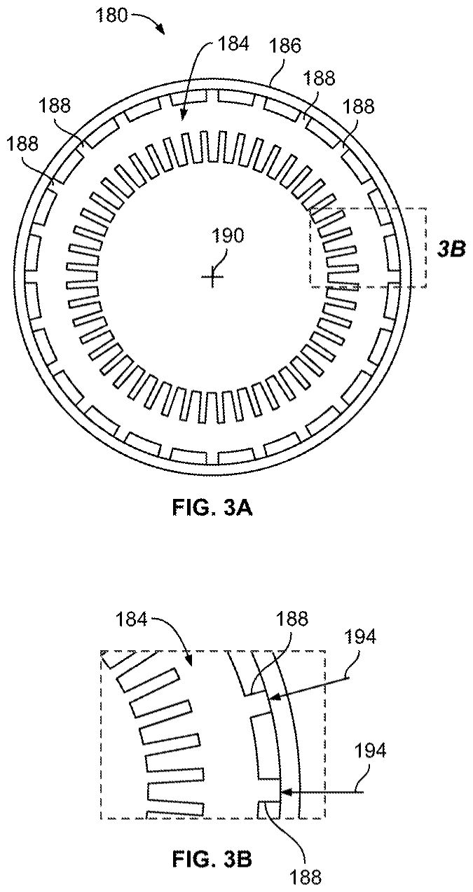

FIGS. 3A and 3B illustrate an example of portions of a prior art electric machine assembly, referred to as an electric machine assembly 180 herein. In this example, the electric machine assembly 180 includes stator tabs oriented to contact an inner surface of a stator housing to generate interference therebetween. For example, the electric machine assembly 180 includes a stator 184 disposed within a housing 186. The stator 184 includes a plurality of stator tabs 188 extending radially outward relative to a stator central axis 190. The stator 184 is arranged with the housing 186 such that interference forces are received at an outer surface of each stator tab 188 as represented by interference force arrows 194.

In this example, operational losses may be experienced by the electric machine assembly 180 due to slippage of the stator 184 relative to the housing 186. For example, the operational losses may be above an acceptable predetermined threshold since the interference forces are only offset in one direction as frictional interference. Further, the interference creates radial pressure onto an outer surface of the stator 184 which results in compression stress at a back-iron portion of the stator 184. This compression stress further increases losses of the stator 184 during operation which then reduces an overall efficiency of the electric machine assembly 180.

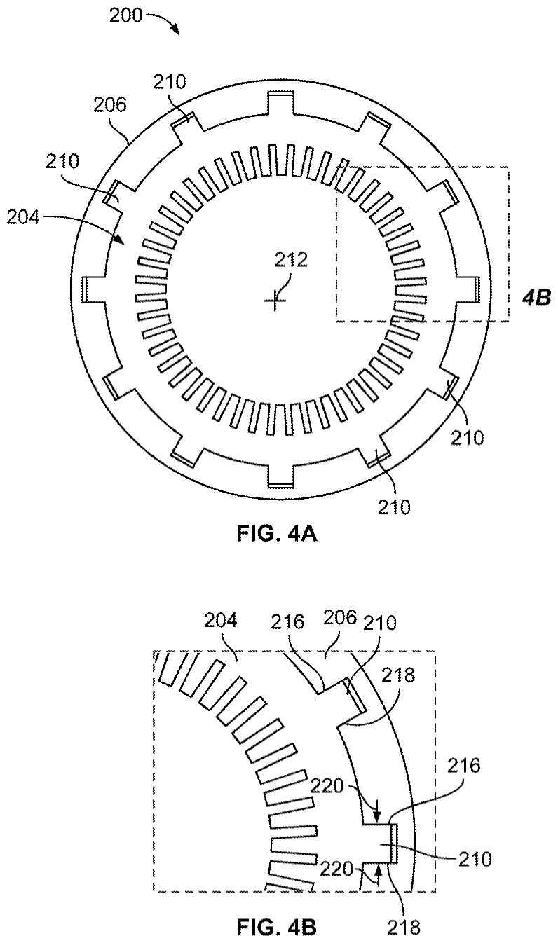

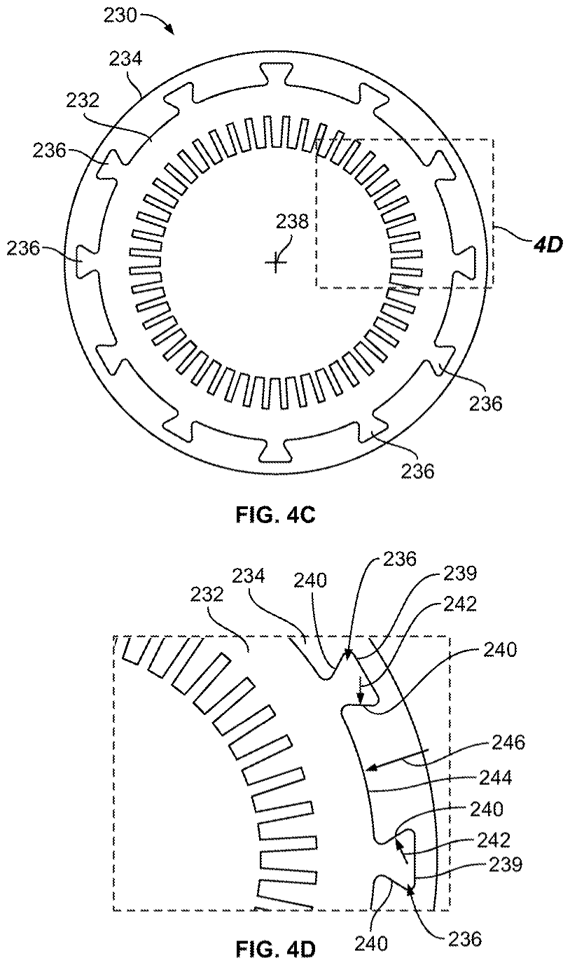

FIGS. 4A and 4B illustrate an example of a portion of a vehicle electric machine assembly, referred to generally as an electric machine assembly 200 herein. The electric machine assembly 200 includes a stator 204 disposed within a housing 206. The stator 204 may also be referred to as a stator core back iron. The stator 204 may include a plurality of stator tabs 210 extending radially outward relative to a central axis 212 of the stator 204. The central axis 212 of the stator 204 may be an axis the same or similar to a central axis of the housing 206. The housing 206 may define a plurality of pockets corresponding to the plurality of stator tabs 210 to receive a respective stator tab 210 therein. Optionally, each of the pockets may be sized to define a spacing between an outer end of a stator tab 210 and a respective pocket surface. Each of the plurality of stator tabs 210 may include a first side 216 and a second side 218. Each of the first side 216 and the second side 218 are arranged for contact with a surface of the housing 206.

For example, the stator 204 and the housing 206 may be arranged with one another such that each of the first side 216 and the second side 218 contacts a respective side of a pocket of the housing 206 to create an interference therebetween as shown by interference force arrows 220. In comparison to the electric machine assembly 180, less interference force is needed to retain the stator 204 in position relative to the housing 206 and prevent slippage since the stator 204 is not relying solely on frictional interference with the housing 206 to prevent slippage during operation. As such, the housing 206 may pull the stator 204 into tension when the electric machine assembly 200 is operating at high temperatures and push the stator 204 into compression at low temperatures.

FIGS. 4C and 4D illustrate an example of a portion of a vehicle electric machine, referred to generally as an electric machine assembly 230 herein. The electric machine assembly 230 includes a stator 232 disposed within a housing 234. The stator 232 may include a plurality of stator tabs 236 extending radially outward relative to a central axis 238 of the stator 232. The housing 234 may define a plurality of pockets corresponding to the plurality of stator tabs 236 to receive a respective stator tab 236 therein.

Each of the plurality of stator tabs 236 may include an outer side 239 and a pair of radial sides 240. Each of the radial sides 240 may be offset at an angle relative to the central axis 238. In one example, the angle may be substantially equal to between zero and ninety degrees. Each of the outer sides 239 may be arranged with a respective pair of the radial sides 240 to define a wedge shape. The wedge shape may assist in anchoring the stator 232 to the housing 234. For example, the stator 232 and the housing 234 may be arranged with one another such that each radial side 240 contacts a respective side of a pocket of the housing 234 to create an interference therebetween as represented by interference force arrows 242. Further, a radial force may be applied from the housing 234 to the stator 232 at a stator surface 244 as represented by force arrow 246.

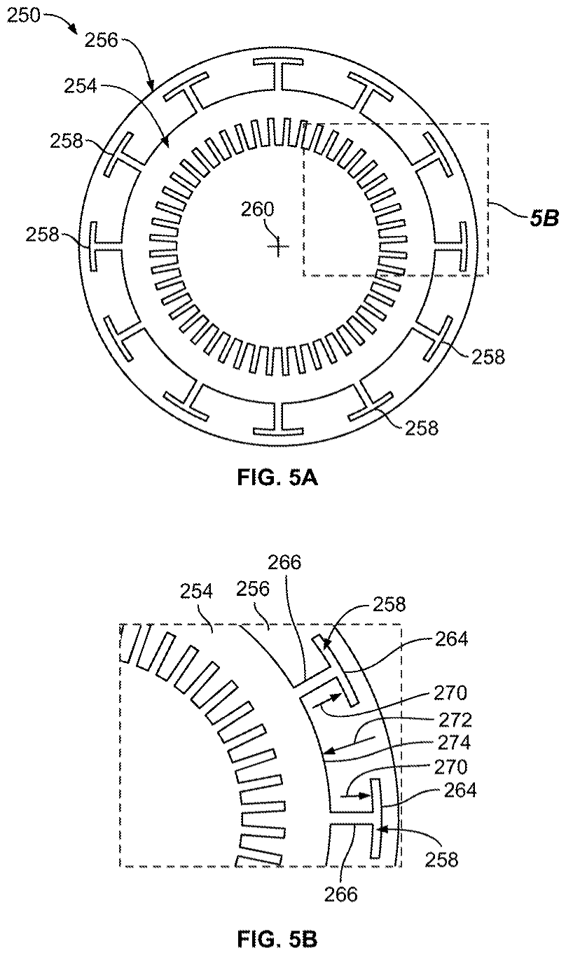

FIGS. 5A and 5B illustrate an example of a portion of an electric machine assembly, referred to generally as an electric machine assembly 250 herein. The electric machine assembly 250 includes a stator 254 disposed within a housing 256. The stator 254 may also be referred to as a stator core back iron. The stator 254 may include a plurality of T-shaped tabs 258 spaced from one another circumferentially about a stator central axis 260. The stator central axis 260 of the stator 254 may be an axis the same or similar to a central axis of the housing 256. The housing 256 may define a plurality of pockets, each corresponding to one of the plurality of T-shaped tabs 258 to receive a respective T-shaped tab 258 therein. Each of the plurality of T-shaped tabs 258 may define an upper portion 264 and a base portion 266. Each of the base portions 266 may define a central axis that intersects the stator central axis 260. The stator 254 may be arranged with the housing 256 such that each of the upper portion 264 and the base portion 266 contact a surface of the housing 256 generating an interference force to assist in preventing slippage of the stator 254 relative to the housing 256 during operation of the electric machine assembly 250.

For example, interference force arrows 270 represent an interference force received by a respective upper portion 264 along a first radial axis during operation of the electric machine assembly 250. As another example, interference force arrow 272 represents an interference force along a second radial axis received by a curved portion of an outer surface 274 of the stator 254. In this example, the stator 254 is pulled into tension as the housing 256 expands due to temperature exposure above a first predetermined threshold and the stator 254 is pushed into compression as the housing 256 contracts due to temperature exposure below a second predetermined threshold. The interference represented by the interference force arrows 270 may be in a direction opposite a direction of the interference represented by the interference force arrow 272. In comparison to the electric machine assembly 180, less interference force is needed to retain the stator 254 in position relative to the housing 256 and prevent slippage since the stator 254 is not relying solely on frictional interference with the housing 256 to prevent slippage during operation.

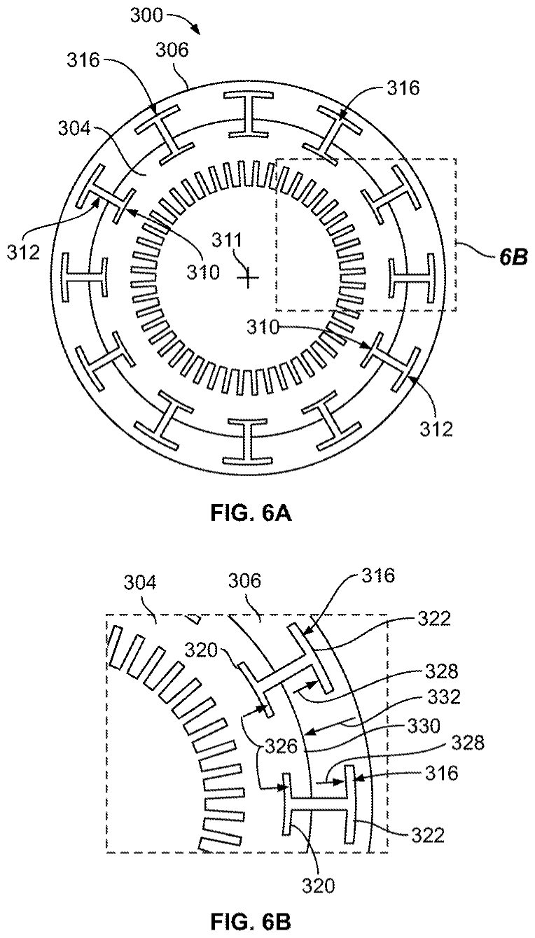

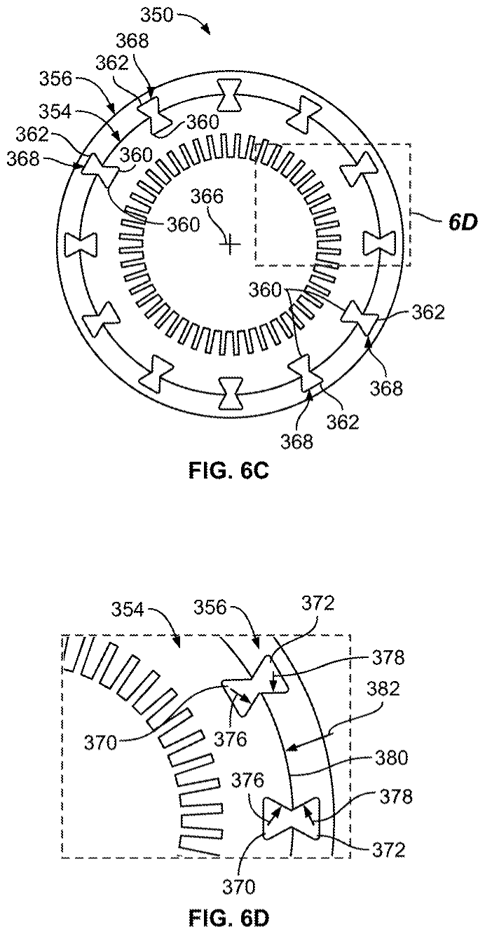

FIGS. 6A and 6B illustrate an example of a portion of a vehicle electric machine assembly, referred to generally as an electric machine assembly 300 herein. In this example, a stator and housing are formed to receive a connecting insert to retain the stator in position relative to the housing. The electric machine assembly 300 may include a stator 304 disposed within a housing 306. The stator 304 may define a plurality of inner T-shaped pockets 310 and the housing 306 may define a plurality of outer T-shaped pockets 312. Each of the plurality of inner T-shaped pockets 310 may be spaced equidistantly from a stator central axis 311. The stator 304 and the housing 306 may be arranged with one another to align each of the plurality of inner T-shaped pockets 310 with one of the plurality of outer T-shaped pockets 312 to form an I-shaped pocket. Each I-shaped pocket may be sized to receive an I-beam insert 316. Each I-shaped pocket may be located relative to the stator central axis 311 such that inclusion of a respective I-beam insert 316 within one of the pockets does not block magnetic flux generated during operation of the electric machine assembly 300.

The stator 304 and the housing 306 may be further arranged with one another such that each I-beam insert 316 exerts interference forces on the stator 304 and the housing 306 during operation of the electric machine assembly 300. For example, each of the I-beam inserts 316 may include an inner portion 320 and an outer portion 322. Each inner portion 320 may exert an interference force against the stator 304 as represented by interference force arrows 326. Each outer portion 322 may receive an interference force from the housing 306 as represented by interference force arrows 328. Additionally, the housing 306 may exert an interference force upon the stator 304 at a stator outer surface 330 as represented by interference force arrow 332. In comparison to the electric machine assembly 180, less interference force is needed to retain the stator 304 in position relative to the housing 306 and prevent slippage since the stator 304 is not relying solely on frictional interference with the housing 306 to prevent slippage during operation.

FIGS. 6C and 6D illustrate another example of an electric machine assembly, referred to generally as an electric machine assembly 350 herein. In this example, a stator and housing are formed to receive a connecting insert to retain the stator in position relative to the housing during operation of the electric machine assembly 350. The electric machine assembly 350 includes a stator 354 disposed within a housing 356. The stator 354 may define a plurality of inner wedge-shaped pockets 360 and the housing 356 may define a plurality of outer wedge-shaped pockets 362. Each of the plurality of inner wedge-shaped pockets 360 may be spaced equidistantly from a stator central axis 366. The stator 354 and the housing 356 may be arranged with one another to align each of the plurality of inner wedge-shaped pockets 360 with one of the plurality of outer wedge-shaped pockets 362 to form a dual-wedge pocket. Each dual-wedge pocket may be sized to receive a dual-wedge insert 368. Each of the dual-wedge pockets may be located relative to the stator central axis 366 such that inclusion of a respective dual-wedge insert 368 within one of the dual-wedge pockets does not block magnetic flux generated during operation of the electric machine assembly 350.

The stator 354 and the housing 356 may be further arranged with one another such that each dual-wedge insert 368 exerts interference forces on the stator 354 and the housing 356 during operation of the electric machine assembly 350. For example, each of the dual-wedge inserts 368 may include an inner portion 370 and an outer portion 372. Each inner portion 370 may exert an interference force against the stator 354 as represented by interference force arrows 376. Each outer portion 372 may exert an interference force against the housing 356 as represented by interference force arrows 378. Additionally, the housing 356 may exert an interference force upon the stator 354 at a stator outer surface 380 as represented by interference force arrow 382. In comparison to the electric machine assembly 180, less interference force is needed to retain the stator 354 in position relative to the housing 356 and prevent slippage since the stator 354 is not relying solely on frictional interference with the housing 356 to prevent slippage during operation.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine assembly comprising:
a housing defining a cavity and an inner surface having pockets spaced radially about a housing central axis; and
a stator disposed within the cavity and defining an outer surface having tabs spaced from one another radially about a stator central axis and each tab including opposing circumferential sides,
wherein the housing and stator are arranged with one another such that each of the opposing circumferential sides contacts a side of a respective pocket to create interference therebetween.

2. The assembly of claim 1, wherein each tab further includes a tab outer surface, and wherein each of the pockets is sized such that a space is defined between each tab outer surface and a respective pocket side.

3. The assembly of claim 1, wherein the housing and stator are further arranged with one another such that the housing pulls the stator into tension when exposed to a temperature over a first predetermined threshold.

4. The assembly of claim 1, wherein the housing and stator are further arranged with one another such that the housing pushes the stator into compression when exposed to a temperature below a second predetermined threshold.

5. The assembly of claim 1, wherein the housing and stator are further arranged with one another such that the interference between the tab and pocket is comprised of at least one force other than a friction force to prevent slippage of the stator within the cavity of the housing.

6. The assembly of claim 1, wherein each of the tabs includes an outer side and a pair of radial sides arranged with one another to define a wedge shape, and wherein each of the radial sides defines an angle offset from the stator central axis.

7. The assembly of claim 1, wherein the housing central axis and the stator central axis are oriented parallel with one another.

8. An electric machine assembly comprising:
a housing defining a cavity and an inner surface having pockets spaced radially about a housing central axis; and
a stator disposed within the cavity and defining an outer surface having T-shaped tabs spaced from one another circumferentially about a stator central axis and each tab including an upper portion and a base portion,
wherein each pocket defines a T shape corresponding to one of the T-shaped tabs, and wherein the housing and stator are arranged with one another such that a first interference is generated between the upper portions of the T-shaped tabs and a surface of a respective pocket.

9. The assembly of claim 8, wherein the housing and stator are further arranged with one another such that as the housing expands due to exposure to a temperature above a first temperature threshold the stator is pulled into tension and such that as the housing contracts due to exposure to a temperature below a second predetermined threshold the stator is pushed into compression.

10. The assembly of claim 8, wherein each base portion defines a radial axis that intersects the stator central axis.

11. The assembly of claim 8, wherein the first interference is further generated due to rotation of the stator and the housing during operation thereof.

12. The assembly of claim 8, wherein the housing and stator are further arranged with one another such that the first interference between the upper portions of the T-shaped tabs and a surface of a respective pocket is comprised of at least one force other than a friction force to prevent slippage of the stator within the cavity of the housing.

13. The assembly of claim 8, wherein the housing and stator are further arranged with one another such that a second interference is generated at a stator outer housing surface between two of the T-shaped tabs and an inner housing surface.

14. The assembly of claim 13, wherein the first interference is generated along a first radial axis intersecting the stator central axis, and wherein the second interference is generated along a second radial axis intersecting the stator central axis in a direction opposite the first interference.

15. An electric machine assembly comprising:
a housing defining a cavity and defining an inner surface having a first insert pocket portion;
a stator disposed within the cavity and defining an outer surface having a second insert pocket portion; and
an insert member,
wherein the housing and stator are arranged with one another such that the portions align with one another to define an insert pocket to receive the insert member therein.

16. The assembly of claim 15, wherein the housing and stator are further arranged with one another such that each insert member is located relative to a stator central axis such that magnetic flux generated by operation of the stator is not substantially blocked by the insert member.

17. The assembly of claim 15, wherein each of the first insert pocket portion of the insert pocket and the second insert pocket portion of the insert pocket define an I shape.

18. The assembly of claim 15, wherein the first insert pocket portion of the insert pocket is an outer wedge-shaped pocket and the second insert pocket portion of the insert pocket is an inner wedge-shaped pocket, wherein the insert member defines a dual-wedge shape, and wherein the housing and the stator are further arranged with one another to receive the dual-wedge shaped insert member within one of the inner wedge-shaped pockets and one of the outer wedge-shaped pockets.

19. The assembly of claim 15, wherein the housing and stator are further arranged with one another such that an interference is generated between the outer surface of the stator between two second insert pocket portions and the inner surface of the housing.

20. The assembly of claim 15, wherein the housing and the stator are further arranged with one another such that an interference therebetween is comprised of at least one force other than a friction force to prevent slippage of the stator within the cavity of the housing.
